(19) United States
(12) Patent Application Publication
(10) Pub. No.: US 2015/0108846 A1
(43) Pub. Date: Apr. 23, 2015

(54) METHOD AND APPARATUS FOR MITIGATING SUB-SYNCHRONOUS RESONANCE IN POWER TRANSMISSION SYSTEM

(71) Applicants: Hailian Xie, Beijing (CN); Bin Li, Beijing (CN); Carl Heyman, Vasteras (SE)

(72) Inventors: Hailian Xie, Beijing (CN); Bin Li, Beijing (CN); Carl Heyman, Vasteras (SE)

(73) Assignee: ABB TECHNOLOGY LTD., Zurich (CH)

(21) Appl. No.: 14/401,960

(22) PCT Filed: Feb. 1, 2013
(86) PCT No.: PCT/CN2013/071267

§ 371 Date: Nov. 18, 2014

(51) Int. Cl. H02J 3/24

(52) U.S. Cl. CPC H02J 3/24
USPC 307/102

(57) ABSTRACT

Method and apparatus for mitigating SSR in power transmission system are provided. The method comprises: checking whether the sub-synchronous resonance (SSR) happens in the power transmission system; checking whether the sub-synchronous resonance is undamped; providing a command to bypass the SC unit when the SSR happens and is undamped. In some embodiments, the method further comprises providing a command to reinsert the SC unit into the power transmission system when the transmission level of the power transmission system is determined to be higher than a predetermined level and there is no fault in the power system. The invention also relates to a corresponding apparatus which can implement the method of the invention.

### FIELD OF THE INVENTION

Embodiments of the present invention generally relate to the field of power transmission system, and more particularly, to a method and apparatus for mitigating sub-synchronous resonance (SSR) in the power transmission system.

### BACKGROUND OF INVENTION

In recent years, a development of wind power has been booming all over the world. In many countries such as China and USA, wind resources are usually on-shore and concentrate in the area far away from load centers. Accordingly, they are also developed in a concentrated mode and transmission of bulk wind energy is inevitable. There currently exist several alternative transmission schemes, namely Ultra High Voltage (UHV) Alternating Current (AC) transmission, line commutated converter (LCC) high-voltage direct current (HVDC), and voltage source converter (VSC) HVDC. Among these schemes, the UHV AC transmission is a cheaper and promising one.

Series compensation (SC) is an effective way to increase power transmission capability of the AC transmission lines. However, if the AC transmission lines are compensated by fixed capacitors, there exists a resonance frequency in sub-synchronous range in the power transmission system, which might cause sub-synchronous resonance (SSR) problems. The SSR risk will be high if the wind farms are connected radially to one end of the AC transmission line and are equipped with an induction generator (IG), including an ordinary IG and a doubly fed induction generators (DFIG). As a matter of fact, the IG and the DFIG are the dominating types of wind generators nowadays.

The SSR problem related to wind power has been drawing more and more attentions in research societies. The SSR will be a potential risk that has to be dealt with in the future.

Generally speaking, there are several possible ways to solve the SSR problem related to wind power, namely, utilizing special control for wind turbine generators, adding damping equipment to the SC or the wind farm, temporarily bypassing the SC, or employing other Flexible Alternative Current Transmission Systems (FACTS) devices for SSR damping. However, since the SSR related to wind power is a relatively new problem, no field proven solution has been reported.

The characteristics of SSR due to SC and wind farms are well known that the SSR risk of the system is high when the wind power generation level is low. Since the SC is not necessary at low transmission level, it is possible to eliminate the SSR by temporarily bypassing the SC. Since the transmission level is low, the system operation without the SC should not be a problem.

The Chinese patent application publication No. CN101465545A discloses a method of bypassing the SC in case of the SSR. With this method, the SC is bypassed upon detection of the SSR occurrence to protect the SC. However, re-insertion of the SC is implemented in a ‘trial-and-error’ way after a pre-set time period (for example, 10-15 minutes), without consideration of system operation conditions. If the SC could not be re-inserted after three tries, the SC will be bypassed permanently and has to be re-inserted manually. This method might work for protection of the SC against the SSR caused by a thermal power plant. However, if this solution is applied in protection of the SC for wind power transmission, manual reinsertion of the SC will very likely be required every now and then. The reason can be explained as following. When the SSR occurs in a wind transmission system, the wind generation level is usually low. It is very unlikely the wind generation will go high within the per-set time period. Therefore, the system will very likely suffer the SSR again if the SC is re-inserted after the pre-set time period. Automatic re-insertion will very likely fail. Another drawback is that each re-insertion try brings disturbances to the power transmission system.

In view of the foregoing, there is a need in the art for a method and means for mitigating SSR in a more efficient and effective way.

### SUMMARY OF INVENTION

In order to mitigate SSR automatically and thus to solve the above problem, one of the objectives of the embodiments of the present invention proposes a novel solution method and apparatus for mitigating SSR in the power transmission system.

In one aspect, embodiments of the present invention provide a method for mitigating SSR in power transmission system. The method comprises the steps of: checking whether the SSR happens in the power transmission system; checking whether the SSR is undamped; providing a command to bypass the SC unit when the SSR happens and is undamped.

In some embodiments, the checking whether the SSR happens in the power transmission system comprises: obtaining a sub-synchronous frequency component from a measured electrical quantity of the power transmission system, comparing a value of the sub-synchronous frequency component with a preset value, determining the SSR happens in the power transmission system if the value of sub-synchronous component is larger than the preset value.

In some embodiments, the checking whether the sub-synchronous resonance is undamped comprises: obtaining present and previous peak values of the sub-synchronous frequency component, and if the present peak value is larger than or equal to previous peak value, determining that the sub-synchronous resonance is undamped.

In some embodiments, there is a locked period between a time point of the SSR first happening and at time point that a second peak of SSR component signal has been detected.

In some embodiments, the value of the sub-synchronous frequency component includes a root mean square (RMS) value, a peak value of the sub-synchronous frequency component.

In some embodiments, the electrical quantity is a current, a voltage or a power of the power transmission system.

In some embodiments, the method of the present invention further comprises the step of providing a command to reinsert the SC unit into the power transmission system when the transmission level of the power transmission system is determined to be higher than a predetermined level and there is no fault in the power system.

In some embodiments, the method further comprises the step of obtaining value of an electrical quantity of the power transmission; comparing the obtained value with a preset value; based on said comparison, determining whether the transmission level of the power transmission system is higher than a predetermined level.

In some embodiments, said electrical quantity is a voltage, a current, or a power of the power transmission system.

In another aspect, an apparatus is provided to implement various embodiments of the method of the first aspect of the invention. The apparatus comprises: a first checking unit configured to check whether the sub-synchronous resonance (SSR) happens in the power transmission system; a second checking unit configured to check whether the sub-synchronous resonance is undamped; a first providing unit configured to provide a command to bypass the SC unit when the SSR happens and is undamped.

In some embodiments, the first checking unit comprises: an obtaining unit configured to obtain a sub-synchronous frequency component from a measured electrical quantity of the power transmission system, a comparing unit configured to compare a value of the sub-synchronous frequency component with a preset value, a determining unit configured to determine the SSR happens in the power transmission system if the value of sub-synchronous component is larger than the preset value.

In some embodiments, the second checking unit comprises: an obtaining unit configured to obtain present and previous peak values of the sub-synchronous frequency component, and a determining unit configured to determine if the present peak value is larger than or equal to previous peak value, determining that the sub-synchronous resonance is undamped.

In some embodiments, there is a locked period between a time point of the SSR first happening and at time point that a second peak of SSR component signal has been detected.

In some embodiments, the value of the sub-synchronous frequency component includes a root mean square (RMS) value, a peak value of the sub-synchronous frequency component.

In some embodiments, wherein the electrical quantity is a current, a voltage or a power of the power transmission system.

In some embodiments, the apparatus further comprises: a second providing unit configured to provide a command to reinsert the SC unit into the power transmission system when the transmission level of the power transmission system is determined to be higher than a predetermined level and there is no fault in the power system.

In some embodiments, the apparatus further comprises: an obtaining unit configured to obtain a value of an electrical quantity of the power transmission; a comparing unit configured to compare the obtained value with a preset value; a determining unit configured to determine whether the transmission level of the power transmission system is higher than a predetermined level based on the comparison. In some embodiments, the electrical quantity is a voltage, a current, or a power of the power transmission system.

In some embodiments, bypass and re-insertion of the SC unit are integrated together and controlled automatically, and no manual operation is required. This makes the solution suitable for systems with high SSR risk, such as wind power transmission systems. This is a big advantage over the existing methods.

In some embodiments, re-insertion of the SC unit is implemented in a controlled manner so that the risk of SSR being brought back is minimized. Unnecessary disturbances to power transmission systems can be avoided.

In detection of the SSR, a unit to determine if the oscillation is being damped or undamped is included. Re-insertion of SC will usually stimulate the SSR. In some cases the oscillations will decay due to system damping. The SSR detection method thus can avoid unnecessary bypassing action of the SC during the re-insertion transient. In addition, it can also avoid unnecessary bypassing action of the SC due to other transients in the system. This makes the control more robust.

Particular embodiments of the subject matter described in this specification can be implemented so as to realize one or more of the following advantages.

Other features and advantages of embodiments of the present invention will also be understood from the following description of specific exemplary embodiments when read in conjunction with the accompanying drawings, which illustrate, by way of example, the principles of the invention.

### BRIEF DESCRIPTION OF DRAWINGS

Embodiments of the present invention will be presented in the sense of examples and their advantages are explained in greater detail below, with reference to the accompanying drawings, wherein:

FIG. 1 is a diagram illustrating a power transmission system which comprises the SC unit in accordance with an exemplary embodiment of the present invention;

FIG. 2 illustrates a flow chart of a method for mitigating SSR in the power transmission system according to embodiments of the present invention;

FIG. 3 shows an example of control system according to embodiments of the present invention;

FIG. 4A shows an example of bypassing control system which is the first part of the control system of mitigating SSR according to embodiments of the present invention;

FIG. 4B shows an especial period of the process shown in FIG. 4A;

FIG. 5 shows the exemplary signals according to embodiments of the present invention;

FIG. 6 shows an example of reinserting control system which is the second part of the control system of mitigating SSR according to embodiments of the present invention;

FIG. 7 is a schematic block diagram of an apparatus that may be configured to practice exemplary embodiments of the present invention;

All the figures are schematic, not necessarily to scale, and generally only show parts which are necessary in order to elucidate the invention, wherein other parts may be omitted or merely suggested.

### DETAILED DESCRIPTION OF EMBODIMENTS

Hereinafter, the principle and spirit of the present invention will be described with reference to the illustrative embodiments. It should be understood, all these embodiments are given merely for the skilled in the art to better understand and further practice the present invention, but not for limiting the scope of the present invention. For example, features illustrated or described as part of one embodiment may be used with another embodiment to yield still a further embodiment. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the description with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

The method and apparatus can be implemented in but not limit to the AC power transmission system.

FIG. 1 is a diagram illustrating a power transmission system 100 which comprises a SC unit in accordance with an exemplary embodiment of the present invention. The power transmission system 100 comprises the SC unit and a control unit 106. Other parts of the system which are not necessary for elucidating the invention may be omitted.

As shown in FIG. 1, the SC unit comprises a capacitor bank 101, a MOV (ZnO varistor) 102, a damping circuit 103, a fast protective device 104 (in some cases not included) and a by-pass switch 105. The capacitor bank 101 connects parallel with the MOV (ZnO varistor) 102, the fast protective device 104 connects parallel with the by-pass switch 105, and the above two parts are connected in series with damping circuit 103.

The control unit 106 is configured to obtain signals from each component of the SC unit and then sends control signals to each of them. The by-pass switch 105 is controllable. The control signal is sent from the control unit to the by-pass switch.

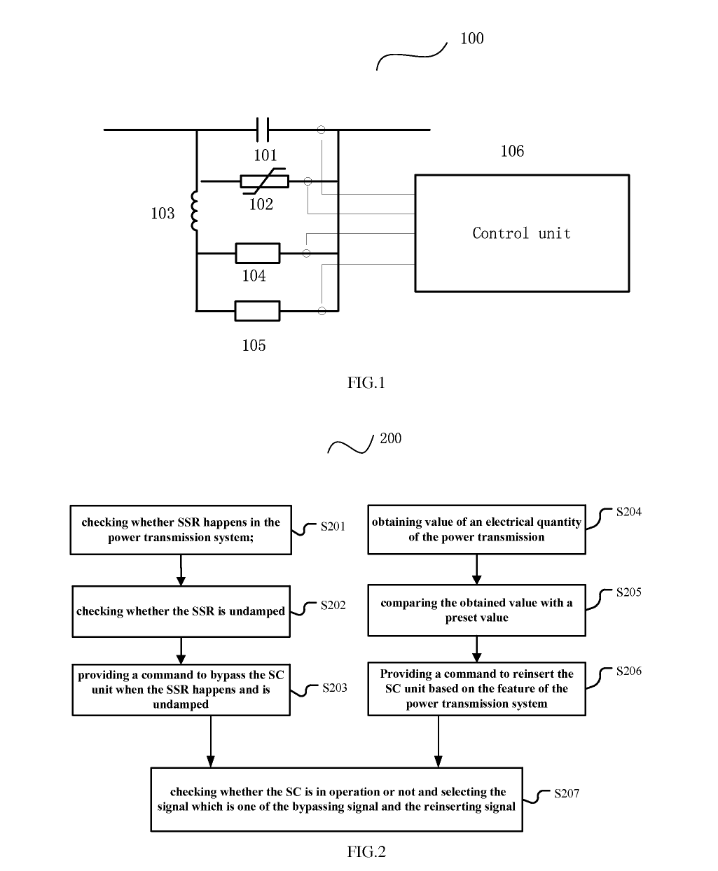

FIG. 2 illustrates a flow chart of a method for mitigating SSR in the power transmission system according to embodiments of the present invention. The method of FIG. 2 may be implemented in the control unit 106.

The method begins at step S201, where the control system checks whether the SSR happens in the power transmission system. In one embodiment, the control system obtains a sub-synchronous frequency component from a measured electrical quantity of the power transmission system; compares a value of the sub-synchronous frequency component with a preset value; then determines the SSR happens in the power transmission system if the value of sub-synchronous component is larger than the preset value. According to embodiments of the present invention, the electrical quantity comprises current, voltage or power of the power transmission system. Of course, other features relating to the SSR may be obtained if needed. The skilled person should appreciate that many well known techniques may be used to obtain the electrical quantity.

Then, at step S202, the control system checks whether the sub-synchronous resonance is undamped. SSR can be stimulated due to disturbances in the system, for example, re-insertion of SC, change of operation conditions or other transients. However, in some cases, the SSR can decay themselves due to system damping. In one embodiment, the sensing is performed based on detection of peak value of current.

In one embodiment, the step S202 may comprise obtaining present and previous peak values of the sub-synchronous frequency component; and determining that the sub-synchronous resonance is undamped when the present peak value is larger than or equal to previous peak value.

At step S203, the control system provides a command to bypass the SC unit when the SSR happens and is undamped.

At step S204, the control system obtains the value of an electrical quantity of the power transmission, wherein the electrical quantity comprises current, voltage and power of the power transmission system.

At step S205, the control system compares the obtained value with a preset value. The value may comprise root mean square (RMS) value, peak value.

Then at step 206, the control system provides a command to reinsert the SC unit into the power transmission system when the transmission level of the power transmission system is determined to be higher than a predetermined level and there is no fault in the power system. For example, during the period when SC is out of service, the wind speed may become big and power generation level will go up. Consequently, voltage drop along the transmission line will increase. When the voltage drop becomes significant, it is necessary to reinsert the SC.

At step 207, the control system checks whether the SC is in operation or not and selects the signal which is one of the bypassing signal and the reinserting signal to send to the SC unit.

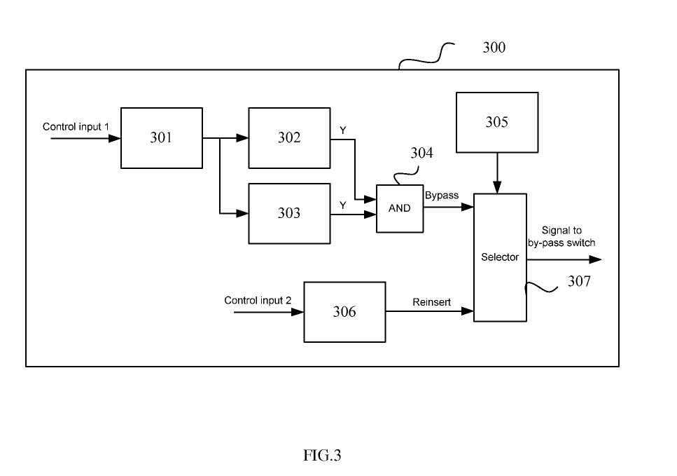

Below will describe the control system in detail. FIG. 3 shows an example of control system according to embodiments of the present invention.

There is two control input (control input 1 and control input 2) in the control system 300.

In the first branch of control system 300, there is an obtaining unit 301 which obtains the control input 1 and extracts the desired component. The inputs of the first checking unit 302 and the second checking unit 303 are both derived from the obtaining unit 301, and the outputs of them are sent to an “and” gate 304. When the SSR happens and is undamped, the output of the “and” gate 304 is high level and sends a bypass command to selector 307.

The second branch of the control system 300 comprises the reinserting control unit 306 of which the input is the control input 2. The reinserting control unit 306 is configured to send a reinserting signal when estimating that the power level reaches a pre-defined level. In some embodiments, the output of the reinserting control unit 306 being high level presents sending the reinserting command. The checking unit 305 is configured to check whether the SC is in operation or not. If SC is in operation, and the output of the “and” gate 304 is high level, the selector 307 selects the signal of the first branch, i.e. bypassing command, if the SC is not in operation, and the output of the reinserting control unit 306 is high level, the selector 307 selects the signal of the second branch, i.e. reinserting command.

In some embodiments, the control input 1 and the control input 2 could be measured voltage, current or power signal. In addition, control input 1 and control input 2 could be the same signal. However, they may also be different from each other.

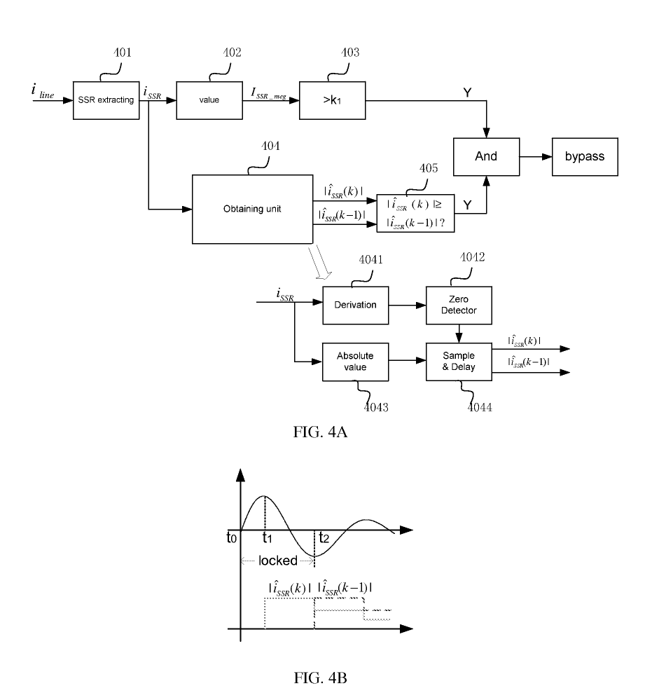

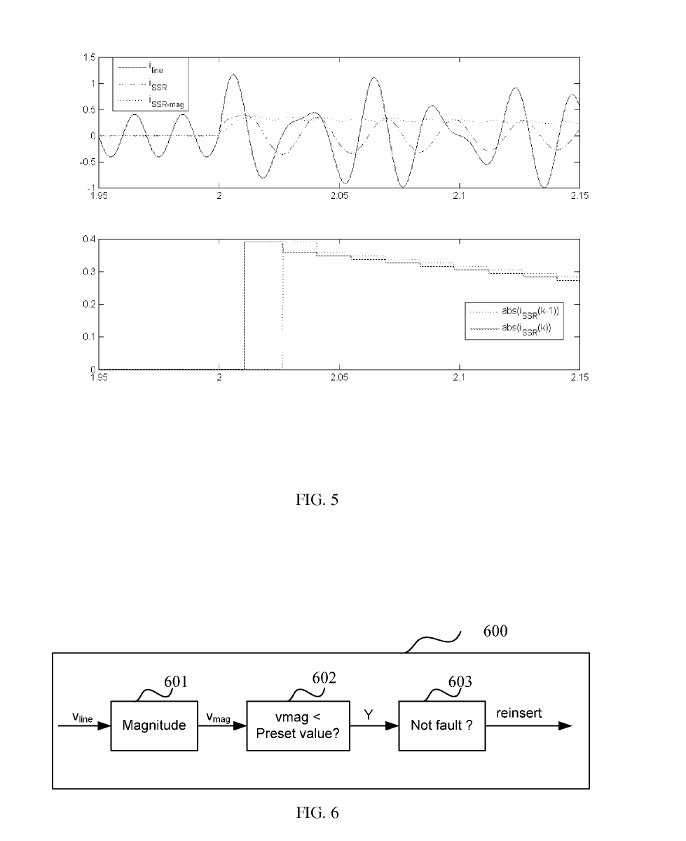

FIG. 4A shows an example of the by-passing control system which is the first part of the control system of mitigating SSR according to embodiments of the present invention. The parameters used in FIG. 4A are listed as follows:
iₗᵢₙₑ: measured current through the transmission line;
i_{SSR}: sub-synchronous component in iₗᵢₙₑ;
I_{SSR}_{_{—}}_{meg}: magnitude value of i_{SSR};
k₁: threshold value for SSR detection;
   |î_{SSR}(k)|: sampled absolute value of present peak of i_{SSR};
   |î_{SSR}(k−1)|: sampled absolute value of the previous peak of i_{SSR};

It is important to note that the input signal “iₗᵢₙₑ” here could also be replaced by other signals, such as V_{SC} (voltage across SC), Pₗᵢₙₑ (power through transmission line), since there is a relationship between those parameters. In one embodiment shown in FIG. 4A, the signal “iₗᵢₙₑ” is available in the SC control system, and it is selected as the input signal for bypass control.

As shown in FIG. 4A, the bypass command is controlled by an “AND” logic, which has two signal inputs. The first one is to check whether SSR appears in the system. The line current iₗᵢₙₑ is measured by sensing unit which is well known in this art such as electric current transducer. Then the sub-synchronous frequency component i_{SSR} is obtained after the fundamental frequency component is removed by SSR extracting unit 401. The value of i_{SSR} is calculated by unit 402 and compared with k₁ which is selected to be slightly larger than zero according to the permissible accuracy of application and the noise in the system so that unnecessary action due to transients can be avoided in comparing unit 403. If I_{SSR}_{_{—}}_{meg} is larger than k₁, the control system deems that SSR occurs.

The second signal is to check whether SSR is being damped or undamped. SSR can be stimulated due to disturbances in the system, for example, re-insertion of SC, change of operation conditions or other transients. However, in some cases, the oscillations can decay themselves due to system damping. Inclusion of this criterion for SSR detection can avoid unnecessary bypass action in these cases.

The obtaining unit 404 can be implemented in a way as shown on the bottom of FIG. 4A. Signal i_{SSR} is sent to the obtaining unit 404. The absolute value of the present and previous peak are sampled and then compared. Every time when zero detector unit 4042 detects that the derivative of i_{SSR} which is obtained from derivation unit 4041 crossing zero, a sample pulse is sent out to sample the absolute value of i_{SSR} which is derived from absolute value unit 4043. The sampled value is held until next peak is sampled in the sample & delay unit 404. The unit 405 compares the two outputs of the obtaining unit 404, i.e. |î_{SSR}(k)| which is sampled absolute value of the present peak of i_{SSR}, and |î_{SSR}(k−1)| which is sampled absolute value of the previous peak of i_{SSR}. If the present peak is large than or equal to the previous peak, i.e. |î_{SSR}(k)|≧|î_{SSR}(k−1)| the control system deems that the oscillation is not being damped. When both criteria are met, the control system will give the “bypass” command to the SC unit.

In some embodiments, the SSR extracting unit 401 can be filter, digital signal processor, or other means which can extract the sub-synchronous frequency component from the measured electrical quantity. The value unit can get such as RMS (root mean square) value, peak value of the sub-synchronous frequency component in electrical quantity.

FIG. 4B shows an especial period of the process shown in FIG. 4A. It is important to note that the SSR detection system will be locked between the time point of SSR first appearing and the second peak of “i_{SSR}” as shown in FIG. 4A. Without this locking unit, the system could have a problem judging whether SSR is undamped. Because at t₀ the zero detector unit 4042 detects that the derivative of i_{SSR} which is obtained from derivation unit 4041 crossing zero, a sample pulse is sent out to sample the absolute value of i_{SSR} which is zero now, the value of zero will held until next peak is sampled in the sample & delay unit 404. Then at t₁ moment, the derivative of i_{SSR} will cross zero again, a sample pulse is sent out to sample the absolute value of i_{SSR} which is the first peak value of i_{SSR}. Then the |î_{SSR}(k−1)| is zero, and |î_{SSR}(k−1)| is the first peak value of i_{SSR} until t2. During t1 and t2 |î_{SSR}(k)| is always bigger than |î_{SSR}(k−1)|, but it does not present that the SSR is undamped. So the SSR detection system must be locked between the time point of SSR first appearing t₁ and the time point of second peak of “i_{SSR}” t₂.

FIG. 5 shows the exemplary signals according to embodiments of the present invention. In the FIG. 5 the X axis presents time and the Y axis presents magnitude value. As shown in FIG. 5, the SSR occurs at 2 s. The Signal “iₗᵢₙₑ” consists of a sinusoidal component with 50 Hz and another sinusoidal component with 35 Hz (SSR). Signal “i_{SSR}” is a sinusoidal component with only 35 Hz. “i_{SSR}_{_{—}}_{mag}” is the magnitude value of “i_{SSR}”. On the bottom of FIG. 5, Sequence “|î_{SSR}(k)|” represents the currently sampled absolute peak value of “i_{SSR}” and Sequence “|î_{SSR}(k−1)|” is the sampled absolute value of the previous peak value of i_{SSR}. The employed signals used in FIG. 5 can help the person who is skilled in the art to understand the control system better.

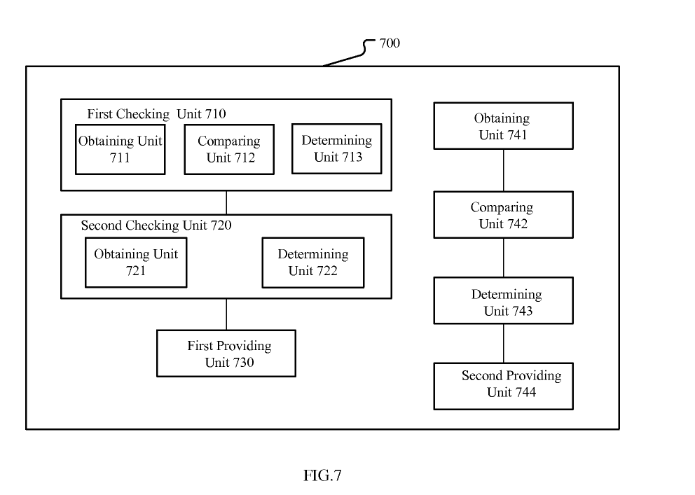

FIG. 6 shows an example of reinserting control system which is the second part of the control system of mitigating SSR according to embodiments of the present invention.

When SC is bypassed, the power transmission system operates without any series compensation. Therefore, the transmission capability of the system decreases. However, research studies have proved that SSR usually happens when power generation level is low. Therefore, at the time point of bypassing the power through the transmission lines is also low. The characteristic of SSR due to SC and wind farms is well known that the risk of system is high when the wind power generation level is low. So the power transmission system without SC should work without any problem.

During the period when SC is out of service, the wind speed may become higher and power generation level will go up. Consequently, voltage drop along the transmission line will increase. When the voltage drop becomes significant, it is necessary to reinsert the SC. The proposed control system 600 is shown in FIG. 6. The system monitors the voltage Vₗᵢₙₑ at the low voltage bus of the SC. The voltage magnitude V_{mag} of Vₗᵢₙₑ is obtained by magnitude unit 601. The unit 602 will determine whether V_{mag} is below preset value. When the voltage drops to a pre-defined level (e.g., 95% of the rated voltage), the unit 603 will check if there is a fault in the system. If there is no fault, a re-insertion command will be sent out to the SC.

In another embodiment, the control system 600 can use current or power signal. But there is some difference. When the signal is the Vₗᵢₙₑ, the unit 603 will check there is a fault if the V_{mag} is below preset value, but when the signal is current or power, the unit 603 will check there is a fault if the current of power is higher than the preset value.

FIG. 7 is a schematic block diagram of an apparatus that may be configured to practice exemplary embodiments of the present invention. The apparatus 700 may be configured to perform methods of the exemplary embodiments of the present invention as illustrated with reference to FIG. 2.

As shown in FIG. 7, the apparatus 700 may comprise a first checking unit 710, a second checking unit 720 and a first providing unit 730. In some embodiments the apparatus 700 may further comprise an obtaining unit 741, a comparing unit 742, a determining unit 743, and a second providing unit 744.

The first checking unit 710 comprises an obtaining unit 711, a comparing unit 712 and a determination unit 713.

The first checking unit 710 is configured to check whether the sub-synchronous resonance (SSR) happens in the power transmission system.

The obtaining unit 711 may obtain a sub-synchronous frequency component from a measured electrical quantity of the power transmission system. The electrical quantities comprise current through the transmission line, voltage across the SC unit, or power through transmission line. If desired, the electrical quantity can also be any other component from the power transmission system or the device thereof.

The comparing unit 712 can compare a value of the sub-synchronous frequency component with a preset value. The preset value is selected to be slightly larger than zero according to the permissible accuracy of application and the noise in the system.

The determination unit 713 determines the SSR happens in the power transmission system if the value of sub-synchronous component is larger than the preset value.

The second checking unit 720 comprises an obtaining unit 721 and a determining unit 722.

The obtaining unit 721 obtains present and previous peak values of the sub-synchronous frequency component. The obtaining unit 721 should set a special period. It is important to note that the SSR detection system must be locked between the time point of SSR first appearing and the second peak of SSR. Without this locking unit, the system could have a problem judging whether SSR is undamped.

The determining unit 722 determines that the sub-synchronous resonance is undamped if the present peak value is larger than or equal to previous peak value.

The first providing unit 730 is configured to provide a command to bypass the SC unit when the SSR happens and is undamped.

In some embodiments, the apparatus 700 may further comprise an obtaining unit 741, a comparing unit 742, a determining unit 743, and a second providing unit 744.

The obtaining unit 741 is configured to obtain a value of an electrical quantity of the power transmission. The comparing unit 742 is configured to compare the obtained value with a preset value. The determining unit 743 is configured to determine whether the transmission level of the power transmission system is higher than a predetermined level, based on said comparison.

The second providing unit 744 is configured to provide a command to reinsert the SC unit into the power transmission system when the transmission level of the power transmission system is determined to be higher than a predetermined level and there is no fault in the power system. The fault detection technique is well known in this art and can have many implementing way, it is not necessary to elucidate the invention, so may be omitted.

It should be understood, the units contained in the apparatus 700 are configured for practicing exemplary embodiments of the present invention. Thus, the operations and features described above with respect to FIG. 2 also apply to the apparatus 700 and the units therein, and the detailed description thereof is omitted here.

It will be appreciated that an embodiment of the method according to the first aspect of the invention may be implemented on a computing device capable of retrieving the electrical quantity of the power transmission system. Embodiments of the apparatus according to the second aspect of the invention may be implemented by circuitry comprising electronic components, integrated circuits (IC), application specific integrated circuits (ASIC), field programmable gate arrays (FPGA), complex programmable logic devices (CPLD), or any combination thereof. Any circuitry may, at least in part, be replaced by processing means, e.g., a processor executing an appropriate software.

To summary, the proposed control scheme provides a solution to mitigate SSR caused by wind power and the SC. The bypass process integrated with reinserting strategy constitutes the whole solution of SSR mitigation. It is designed for wind power transmission area. However, it could also be applied in the area where the power is supplied not only by wind farms but also by traditional power plants such as thermal power plant and hydro power plant.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It should also be noted that the above described embodiments are given for describing rather than limiting the invention, and it is to be understood that modifications and variations may be resorted to without departing from the spirit and scope of the invention as those skilled in the art readily understand. Such modifications and variations are considered to be within the scope of the invention and the appended claims. The protection scope of the invention is defined by the accompanying claims. In addition, any of the reference numerals in the claims should not be interpreted as a limitation to the claims. Use of the verb “comprise” and its conjugations does not exclude the presence of elements or steps other than those stated in a claim. The indefinite article “a” or “an” preceding an element or step does not exclude the presence of a plurality of such elements or steps.

1. A method used in a power transmission system comprising
a series compensation (SC) unit, said method comprising:
checking whether a sub-synchronous resonance (SSR) happens in a power transmission system;
checking whether the sub-synchronous resonance is undamped; and
providing a command to bypass the SC unit when the SSR happens and is undamped.

2. The method as claimed in claim 1, wherein checking whether the SSR happens in the power transmission system comprises:
obtaining a sub-synchronous frequency component from a measured electrical quantity of the power transmission system;
comparing a value of the sub-synchronous frequency component with a preset value; and
determining the SSR happens in the power transmission system if the value of sub-synchronous component is larger than the preset value.

3. The method as claimed in claim 1, wherein checking whether the sub-synchronous resonance is undamped comprises:
obtaining present and previous peak values of the sub-synchronous frequency component; and
if the present peak value is larger than or equal to previous peak value, determining that the sub-synchronous resonance is undamped.

4. The method as claimed in claim 3, wherein there is a locked period between a time point of the SSR first happening and at time point that a second peak of SSR component signal has been detected.

5. The method as claimed in claim 2, wherein the value of the sub-synchronous frequency component include a root mean square (RMS) value, a peak value of the sub-synchronous frequency component.

6. The method as claimed in claim 2, wherein the electrical quantity is a current, a voltage or a power of the power transmission system.

7. The method as claimed in claim 1, further comprising,
providing a command to reinsert the SC unit into the power transmission system when a transmission level of the power transmission system is determined to be higher than a predetermined level and there is no fault in the power system.

8. The method as claimed in claim 7, further comprising:
obtaining a value of an electrical quantity of the power transmission;
comparing the obtained value with a preset value; and
based on said comparison, determining whether the transmission level of the power transmission system is higher than a predetermined level.

9. The method as claimed in claim 8, wherein said electrical quantity is a voltage, a current, or a power of the power transmission system.

10. An apparatus used in a power transmission system comprising a series compensation (SC) unit, said apparatus comprising:
a first checking unit configured to check whether the sub-synchronous resonance (SSR) happens in the power transmission system;
a second checking unit configured to check whether the sub-synchronous resonance is undamped; and
a first providing unit configured to provide a command to bypass the SC unit when the SSR happens and is undamped.

11. The apparatus as claimed in claim 10, wherein the first checking unit comprises:
an obtaining unit configured to obtain a sub-synchronous frequency component from a measured electrical quantity of the power transmission system;
a comparing unit configured to compare a value of the sub-synchronous frequency component with a preset value;
a determining unit configured to determine the SSR happens in the power transmission system if the value of sub-synchronous component is larger than the preset value.

12. The apparatus as claimed in claim 10, wherein the second checking unit comprises:
an obtaining unit configured to obtain present and previous peak values of the sub-synchronous frequency component; and
a determining unit configured to determine if the present peak value is larger than or equal to previous peak value, determining that the sub-synchronous resonance is undamped.

13. The apparatus as claimed in claim 12, wherein there is a locked period between a time point of the SSR first happening and at time point that a second peak of SSR component signal has been detected.

14. The apparatus as claimed in claim 11, wherein the value of the sub-synchronous frequency component include a root mean square (RMS) value, a peak value of the sub-synchronous frequency component.

15. The apparatus as claimed in claim 11, wherein the electrical quantity is a current, a voltage or a power of the power transmission system.

16. The apparatus as claimed in claim 10, further comprising:
a second providing unit configured to provide a command to reinsert the SC unit into the power transmission system when the transmission level of the power transmission system is determined to be higher than a predetermined level and there is no fault in the power system.

17. The apparatus as claimed in claim 16, further comprising:
an obtaining unit configured to obtain a value of an electrical quantity of the power transmission;
a comparing unit configured to compare the obtained value with a preset value; and
a determining unit configured based on said comparison, determine whether the transmission level of the power transmission system is higher than a predetermined level.

18. The apparatus as claimed in claim 17, wherein said electrical quantity is a voltage, a current, or a power of the power transmission system.

19. The method as claimed in claim 2, wherein checking whether the sub-synchronous resonance is undamped comprises:
obtaining present and previous peak values of the sub-synchronous frequency component; and
if the present peak value is larger than or equal to previous peak value, determining that the sub-synchronous resonance is undamped.

20. The apparatus as claimed in 11, wherein the second checking unit comprises:
an obtaining unit configured to obtain present and previous peak values of the sub-synchronous frequency component; and
a determining unit configured to determine if the present peak value is larger than or equal to previous peak value, determining that the sub-synchronous resonance is undamped.
